(19) United States
(12) Patent Application Publication
(10) Pub. No.: US 2004/0131801 A1
(43) Pub. Date: Jul. 8, 2004

(54) Multi-purpose collapsible structure

(76) Inventor: Hin Mung Wong, Tsimshatsui (HK)

Correspondence Address: Kit M. Stetina, Esq., STETINA BRUNDA GARRED & BRUCKER, Suite 250, 75 Enterprise, Aliso Viejo, CA, 92656, US

(21) Appl. No.: 10/337,744

(22) Filed: Jan. 7, 2003

(51) Int. Cl. A45F 3/00

(52) U.S. Cl. 428/12

(57) ABSTRACT

There is provided a multi-purpose collapsible structure comprising a structure housing having front and base peripheral edges adjoined to each other. The structure housing has front and base apertures which are elongated adjacent the front and base peripheral edges, respectively. Front and base flexible rods are extended within the front and base apertures, respectively. The structure housing further has a biasing member disposed at each location where the front and base rods converge toward each other to engage the rods therewith. Each of the biasing members maintain the front rod generally perpendicular to the base rod in an extended position whereby the front rod is movable thereto via application of force opposing the biasing members. This forms a stowed position and collapse the structure housing.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to collapsible structures, and more particularly to an improved, multi-purpose collapsible structure which can transition between extended and stowed positions through the use of its specially interconnected fiberglass rods and torsional spring assemblies so as to afford a conveniently portable structuring as a pet shelter, a play gym and/or a golf chipping target.

People engage in various personal activities throughout their daily lives. As such, they tend to purchase wide range of products that are needed to support each of these different activities, the occurrence of which may often lead to inconveniences of storage especially in limited residential units such as apartments and the like.

For example, a typical person in his capacity as a pet owner must provide a proper sheltering for his pet. Further exemplary to this nature is the person's obligation as a parent to provide a suitable playing space for his infant and/or small child in order to render proper childcare. Moreover, that person may also seek to satisfy his own recreational appetite for improving his golf game at home as commonly done by many golf lovers whose busy schedules do not permit them to frequently visit an actual golf course and/or driving range.

Consequently, a person typically has to buy various different products in order meet his duties as a responsible pet owner, a caring parent, and a golf enthusiast. These products can range from purchasing an indoor and/or outdoor pet shelter from a pet store, an indoor and/or outdoor infant play gym from a toy store, and an indoor and/or outdoor golf chipping target from a golf specialty store. Each of these products are specifically tailored for their own unique objective, and typically cannot be cross-used for objectives other than for their own.

Although the products described above may prove to be adequate in fulfilling their intended objectives (i.e., pet shelter, infant play gym and golf chipping target), their purchaser must undergo the hassle of finding post-use storage spaces for each of these products. This typically is troublesome for the purchaser who must allocate his limited residential space accordingly for storage of these products. It may even be very difficult for the purchaser living in a very confined residential unit such as an apartment complex who simply cannot appropriate any storage space for each of these products.

In either of these situations, the person purchasing these products for pet sheltering, child caring and/or golf practicing objectives must endure the painstaking process of allocating sufficient spaces for their storage. If none are presentable, that person may have to sacrifice one over the other which is likely to have unpleasant consequences toward his personal lifestyle. Such is a common phenomenon that many people have to face today.

Thus, there exists a strong need for a single product which can be used to provide a pet shelter, an infant play gym and a golf chipping target so as to eliminate the need to purchase multiple products therefor and allocate storage spaces for each of those products. Moreover, there exists a further need for such single product which can achieve all of these objectives with minimized need for storage space after use while being portable to facilitate its relocations between various storage spaces.

### BRIEF SUMMARY OF THE INVENTION

The present invention specifically addresses and alleviates the above-described deficiencies by providing a single, multi-purpose collapsible structure which can be used as a pet shelter, a play gym and/or a golf chipping target so as to rid of any need to purchase multiple products therefor and allocate storage spaces for each of those products. Further to portraying such multi-applicability, this single collapsible structure can retract from an extended position to a stowed position through the use of its specially interconnected fiberglass rods and torsional spring assemblies to minimize its need for storage space after use. Such retraction also allows the structure to be portable which increases its user-friendliness while facilitating its relocations between different storage spaces.

In accordance with a preferred embodiment of the present invention, there is provided a collapsible structure which can condense into a space-saving, portable unit after being used as a pet shelter, a play gym and/or a golf chipping target. However, it is expressly contemplated herein that such structure may be utilized for applications other than the ones described above (e.g., outdoor tent, goal post, closet, shade shelter, etc.). The collapsible structure first features an encapsulating structure housing which is produced by attaching an outer layer and an inner layer to each other, preferably via stitching. Although such layers may be fabricated from any pliable material, it is preferred that they be manufactured from fabric such as nylon.

Alternatively, the outer and inner layers forming the structure housing may be fabricated from a netted material. In this respect, the structure housing would define a netted housing surface which allows visual communication with the outside environment. By providing such surface, it further allows fresh air and cool breezes to be drawn into an interior of the structure housing. Furthermore, it is expressly recognized herein that netted windows may be selectively formed on the structure housing in lieu of the netted housing surface which would virtually produce the same effects as that of the netted housing surface.

The structure housing includes an opening which leads to the interior thereof. This opening is preferably formed between the boundary set by the structure housing's front peripheral edge. Optionally, an elongate cushion strip may be extended along the front peripheral edge so as to provide a padded opening into the interior of the structure housing. The opening may be variably sized and display multiple configurations (e.g., circular, triangular, rectangular, etc.) depending upon the placement of flexible rods' ends and/or their memory retaining body characteristics. This aspect of the invention will be discussed later.

In the preferred embodiment of the present invention, a cushion member is removably inserted into the interior of the structure housing via its opening. This cushion member is intended to give comfort to an occupant (e.g., pet, infant, small child and the like) by providing a layer of padding. However, it should be noted that the structure housing may be used without the cushion member which is merely a preferred optional feature. The cushion member can be removed from the structure housing at any time such as when the collapsible structure is ready to be stored so that it too can be stored along therewith, or simply washed or dusted to provide a clean layer of padding to the occupant.

Optionally, a toy anchor may be provided within the interior of the structure housing. This toy anchor may be hung from an interior ceiling of the structure housing or attached to an interior floor thereof. The toy anchor is utilized for securely engaging various small objects (e.g., baby toys) via elongated strings and the like so that babies and small infants can play with them without the worries of inadvertently swallowing the objects. Of course, more than one toy anchors may be provided within the structure housing should it be desired to do so.

In the preferred embodiment, a base peripheral edge is adjoined to the front peripheral edge along a lower section of the structure housing defined between first and second housing locations. Respectively elongated along the front and base peripheral edges are a front aperture and a base aperture. These apertures are preferably formed through selectively stitching the outer and inner layers together along the portions of the structure housing immediately adjacent to the front and base peripheral edges. In this respect, the front and base apertures can be defined between the outer and inner layers. However, the formation of such apertures should not be limited merely to stitching of layers as other means (e.g., bonding by adhesives, fastening by fasteners or staples, or retrofitting separate fabrics to inner or outer layer) may be used to create the same.

The front and base apertures converge and communicate with each other about the first and second housing locations. The importance of this inventive aspect will be described shortly below. Furthermore, additional aperture or apertures may be formed between the front and base apertures. Like the two previously mentioned apertures, these intermediate aperture(s) are also designed to extend about the structure housing and converge toward the first and second housing locations. The intermediate aperture(s) can be formed in the similar manner as that of the front and base apertures.

In accordance with a preferred embodiment of the present invention, front and base rods are extended within the front and base apertures, respectively. These rods are preferably flexible in nature so that they may sufficiently bend and form the desired configuration of the structure housing. As such, the material of choice for the front and base rods is fiberglass which should provide the necessary flexibility thereto.

Intermediate flexible rods corresponding to the number of intermediate apertures may be further utilized for supporting the configuration of the structure housing. More specifically, the intermediate flexible rods are extended within the intermediate apertures and maintained in place via stitching or friction fit so as to provide the requisite rigidity to the structure housing at its areas between the front and base peripheral edges. The intermediate rods are preferably fabricated from the same material as the front and base flexible rods.

In the preferred embodiment of the present invention, biasing members are disposed at each location where the front and base rods converge toward each other. As the front rod's first front rod end and the base rod's first base rod end converge at the first housing location, a biasing member should be disposed thereat. Another biasing member is placed at the second housing location since the front rod's second front rod end and the base rod's second base rod end converge thereabout.

These biasing members are preferably torsional spring assemblies which are used for alternating the front flexible rod between an extended position and a stowed position with respect to the base flexible rod. More specifically, although any biasing assembly which maintains the front rod in the extended position would suffice, each of the presently used biasing members comprise front and base receivers which dispose a torsional spring therebetween. Such torsional spring operates to assert a spring biased force that sustains the front receiver generally perpendicular to the base receiver. Only by manually applying a force that opposes such spring biased force can the front receiver move rotatably toward the base receiver.

The biasing members disposed at the first and second housing locations of the structure housing engage the ends of the front and base flexible rods. This allows the extended and stowed positions to be continually formed which in turn causes the structure housing to be erected and collapsed. More particularly, the biasing member disposed at the first housing location engages the first front and base rod ends respectively through its front and base receivers. Likewise, the biasing member at the second housing location similarly engages the second front and base rod ends respectively through its own front and base receivers.

Through such engagements, the base flexible rod is positioned toward the ground while the front flexible rod is naturally maintained generally perpendicular to the base rod, hence defining the extended position. When a manual force is applied opposite to the spring biased force, the front rod is allowed to move toward the base rod through the rotations of the front receivers to thereby form the stowed position. Upon reaching this position wherein the front rod is maintained generally parallel to the base rod, fastening mechanisms such as loop and hook fastening strips which are respectively formed adjacent the front and base peripheral edges can be used to preserve the structure housing in its collapsed state.

In operation, the present multi-purpose collapsible structure can be used for a variety of applications but mainly used as a pet shelter, an infant play gym and/or a golf chipping target. In order to apply the collapsible structure for these purposes, the already collapsed structure is first taken out of storage for use in indoor or outdoor settings. Thereafter, the loop and hook fastening strips are unfastened wherein the structure housing would then naturally spring up into the extended position. Thus, the structure housing is now extended in its full configuration and is ready for utilization.

If the present collapsible structure is to be used for sheltering pets, then its user may choose to place the cushion member within the interior of the structure housing. This would provide a layer of padding and thus comfort to the user's pets. This specified structure would also apply toward being used as an infant play gym wherein the only difference might be the incorporation of toy anchor(s) within the interior of the structure housing. Of course, the present collapsible structure may function toward these uses without the cushion member.

If the present collapsible structure is intended to be used as a golf chipping target, then the user may simply face toward its opening and strike the golf balls thereto. The golf balls would then travel along that direction into the opening and be contained within the structure housing. By being contained therein, the golf balls can then be easily collected from the interior of the structure housing.

After using the present collapsible structure, the cushion member (if present) is taken out from the structure housing. Then, the collapsible structure is collapsed into the stowed position whereby the loop and hook fastening strips are fastened together in order to maintain the structure in that position. The collapsible structure is thereafter stored in a storage space for future use.

### BRIEF DESCRIPTION OF THE DRAWINGS

These as well as other features of the present invention will become more apparent upon reference to the drawings wherein:

FIG. 1 is a perspective view of a multi-purpose collapsible structure constructed in accordance with a preferred embodiment of the present invention and including a structure housing which forms an opening leading to an interior thereof;

FIG. 2 is a side view of the structure housing shown in FIG. 1 and illustrating its use of multiple flexible rods which collectively support the housing in an extended position;

FIG. 3 is a side view of the structure housing shown in FIG. 1 and illustrating its loop and hook fastener strips which engage with each other to maintain the housing in a stowed position;

FIG. 4 is a side view of the structure housing shown in FIG. 1 and illustrating an alternative housing surface which is fabricated from a netted material;

FIG. 5 is a perspective view of front and base flexible rods shown in FIG. 2 which are engaged to each other through the use of biasing members located at first and second housing locations;

FIG. 6 is an exploded perspective view of one of the biasing members shown in FIG. 5 and illustrating its front and base receivers which dispose a torsional spring therebetween;

FIG. 7 is a perspective view of the structure housing shown in FIG. 1 and including an opening which is generally circular in configuration;

FIG. 8 is a front view of the structure housing shown in FIG. 1 and including an opening which is generally oval in configuration;

FIG. 9 is a front view of the structure housing shown in FIG. 1 and including an opening which is generally rectangular in configuration;

FIG. 10 is a front view of the structure housing shown in FIG. 1 and including an opening which is generally triangular in configuration; and

FIG. 11 is a perspective view of a multi-purpose collapsible structure constructed in accordance with an alternative embodiment of the present invention.

### DETAILED DESCRIPTION OF THE INVENTION

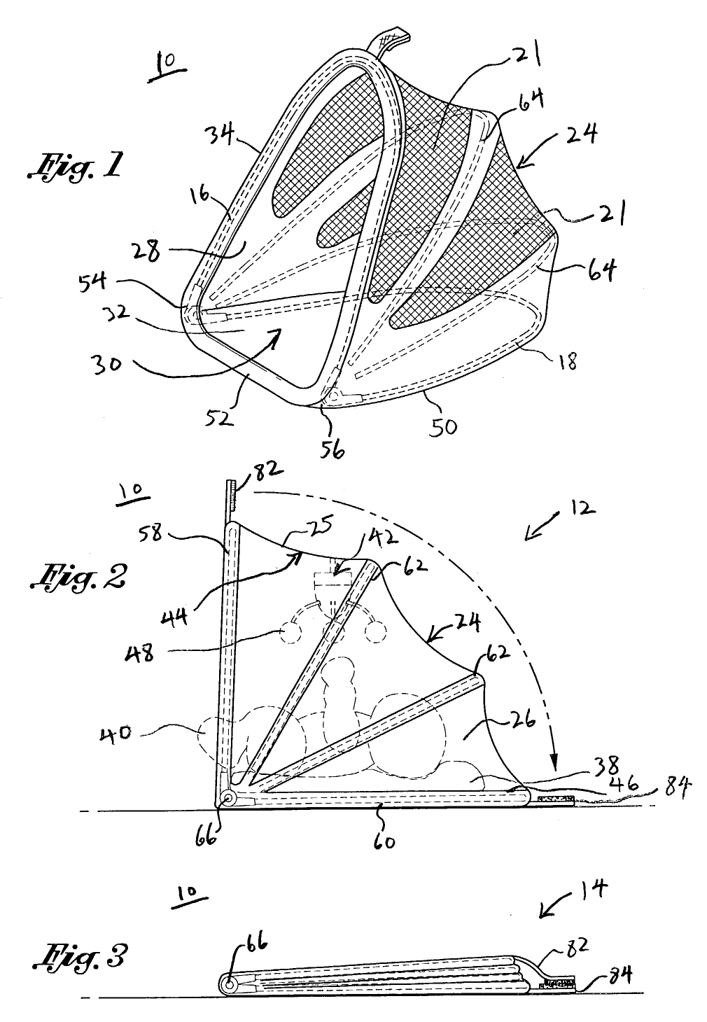

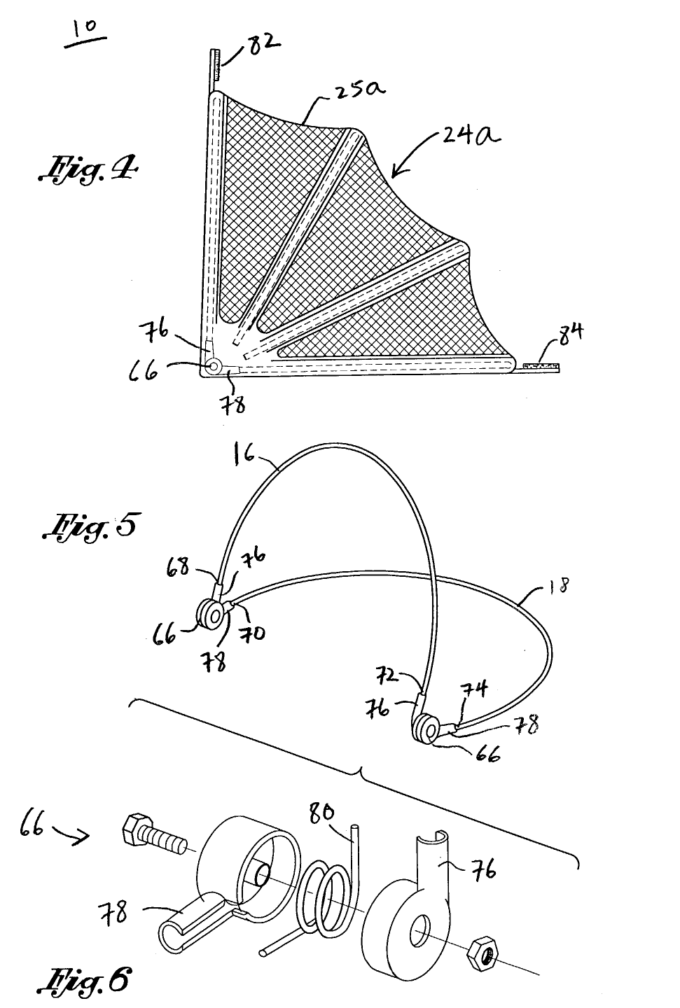

Referring now to the drawings wherein the showings are for purposes of illustrating preferred embodiments of the present invention only, and not for purposes of limiting the same, FIG. 1 perspectively illustrates a multi-purpose collapsible structure 10 constructed in accordance with a preferred embodiment of the present invention. As indicated above, this single collapsible structure 10 is able to be used as a pet shelter, a play gym and/or a golf chipping target. This effectively eliminates the need to purchase a variety of different products for those purposes which greatly reduces the amount of storage spaces that each of those products would occupy.

In addition to possessing such advantage, the single, multi-purpose collapsible structure 10 of the present invention is retractable from its extended position 12 to its stowed position 14 by using its specially interconnected flexible rods 16, 18 and biasing members 66. This further reduces the amount of storage space that it needs after use. Such retraction capability allows the collapsible structure 10 to be portable which increases its user-friendliness while facilitating its relocations between different storage spaces. It is recognized herein that the present collapsible structure 10 may be used in different contexts than the ones specifically pointed out above (e.g., outdoor tent, goal post, closet, shade shelter, etc.).

Referring more particularly to FIGS. 1 and 2, the collapsible structure 10 of the present invention comprises an encapsulating structure housing 24. This structure housing 24 can be created through attaching an outer layer 26 and an inner layer 28 to each other. Although such layers 26, 28 may be attached through various procedures, it is preferred that they be stitched to each other. Furthermore, the outer and inner layers 26, 28 may be fabricated from any pliable material. However, a fabric material such as nylon is the preferred material.

Referring now to FIG. 4 only, the structure housing 24a may be alternatively formed through the use of outer and inner layers 26a, 28a which are fabricated from a netted material. Through the use of such netted layers 26a, 28a, the structure housing 24a features a netted housing surface 25a which allows visual communication with the outside environment. Providing the netted housing surface 25a further allows the fresh air and cool breezes to flow into this alternative structure housing 24a. Additionally, a netted window or windows 21 (shown in FIG. 1) may be selectively formed on the structure housing 24a in lieu of the netted housing surface 25a which would essentially produce the same effects as that of the netted housing surface 25a.

Referring now back to FIG. 1, the structure housing 24 includes an opening 30. This opening 30 leads to an interior 32 of the structure housing 24 and thus can be used to access the same. The opening 30 is preferably formed between the boundary set by the front peripheral edge 34 of the structure housing 24. Moreover, an elongate cushion strip 36 may be optionally extended along the front peripheral edge 34 so as to provide a padded opening into the interior 32 of the structure housing 24. This elongate cushion strip 36 would prevent babies and/or small infants from injuring themselves should they accidentally fall thereupon when entering the structure housing 24 through its opening 30.

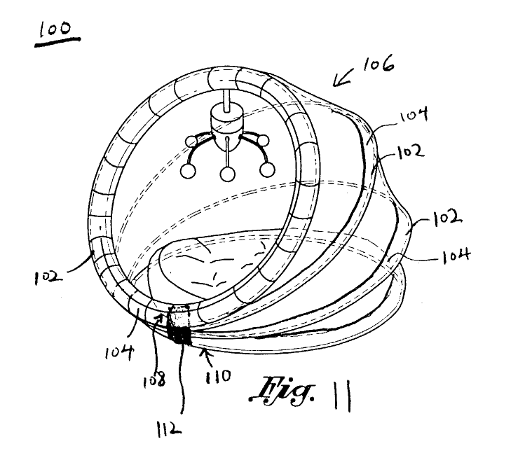

As shown in FIGS. 1 and 7-10, the opening 30 of the structure housing 24 may yield a plurality of sizes and configurations. For instance, the opening 30a may portray a generally circular configuration which may be formed by placing the ends of the front and base flexible rods 16, 18 more closely together (shown in FIG. 7). A generally oval opening 30b may also be formed in the same manner (shown in FIG. 8). Further, a generally rectangular opening 30c (shown in FIG. 9) or a generally triangular opening 30d (shown in FIG. 10) may be formed in lieu of the other configurations through the selective placement of the front and base flexible rods' ends and/or through the bending of the rods 16, 18 whose body characteristics may portray memory retaining capabilities.

Referring now to FIGS. 1, 2 and 7, a cushion member 38 may be removably placed within the interior 32 of the structure housing 24 via its opening 30 or 30a. The cushion member 38 is intended to provide a layer of padding to the collapsible structure's occupant 40 (e.g., pet, infant, small child and the like) which would inevitably provide comfort to the occupant 40. However, the use of cushion member 38 is strictly a preferred optional feature which enhances the overall use of the collapsible structure 10. The cushion member 38 can be removed from the structure housing 24 at any time so that it may be separately stored with the collapsible structure 10, or washed or dusted so as to provide a clean layer of padding to its occupant 40.

FIGS. 1, 2 and 7 illustrate a toy anchor 42 which may be optionally provided within the interior 32 of the structure housing 24. In particular, this toy anchor 42 may be hung from an interior ceiling 44 of the structure housing 24 or attached to an interior floor 46 thereof. The toy anchor is essentially used to secure small objects 48 such as baby toys via elongated strings and the like. This allows babies and small infants 40 to play with their toys 48 without the worries of inadvertently swallowing them. Of course, more than one toy anchors 42 may be provided within the interior 32 of the structure housing 24.

Referring now back to FIGS. 1 and 2, a base peripheral edge 50 is adjoined to the front peripheral edge 34 along a lower housing section 52 of the structure housing 24. The lower housing section 52 is defined between a first housing location 54 and a second housing location 56. Respectively elongated along the front and base peripheral edges 34, 50 are a front aperture 58 and a base aperture 60. Preferably, these apertures 58, 60 are formed through selectively stitching the outer and inner layers 26, 28 to each other along the portions of the structure housing 24 immediately adjacent to the front and base peripheral edges 34, 50. In this respect, the front and base apertures 58, 60 are created between the outer and inner layers 26, 28. However, the formation of such apertures 58, 60 should not be limited solely to stitching of layers 26, 28 as other means (e.g., bonding by adhesives, fastening by fasteners or staples, or retrofitting separate fabrics to inner or outer layer) may be used to create the same.

The front and base apertures 58, 60 are sized and configured to converge and communicate with each other at or about the first and second housing locations 54, 56. Furthermore, additional aperture or apertures 62 may be provided between the front and base apertures 58, 60. Similar to the front and base apertures 58, 60, these intermediate aperture(s) 62 are also adapted to extend about the structure housing 24 and converge toward the first and second housing locations 54, 56. It should be noted that the intermediate aperture(s) 62 may be formed in the similar fashion as that of the front and base apertures 58, 60.

Referring to FIGS. 2 and 5, there are provided front and base flexible rods 16, 18 which are respectively extended within the front and base apertures 58, 60. The front and base flexible rods 16, 18 are preferably fabricated from a fiberglass material which allows such rods 16, 18 to sufficiently bend and form the configuration of the structure housing 24.

One or more intermediate flexible rods 64 may be provided in order to solidly support the configuration of the structure housing 24. More specifically, the intermediate rod(s) 64 corresponding to the number of intermediate aperture(s) 62 is used for this purpose. This intermediate flexible rod(s) 64 is extended within the intermediate aperture(s) 62 and is secured in place via stitching or friction fit so as to provide the requisite rigidity to the housing surface 25 of the structure housing 24. Preferably, the intermediate flexible rod(s) 64 is also fabricated from the fiberglass material.

A biasing member 66 is disposed at each of the locations where the front and base flexible rods 16, 18 converge toward each other, namely, the first and second housing locations 54, 56. More precisely, the front rod's first front rod end 68 and the base rod's first base rod end 70 converge at the first housing location 54 wherein a biasing member 66 is disposed thereat. Another biasing member 66 is placed at the second housing location 56 since the front rod's second front rod end 72 and the base rod's second base rod end 74 converge toward each other about such location 56.

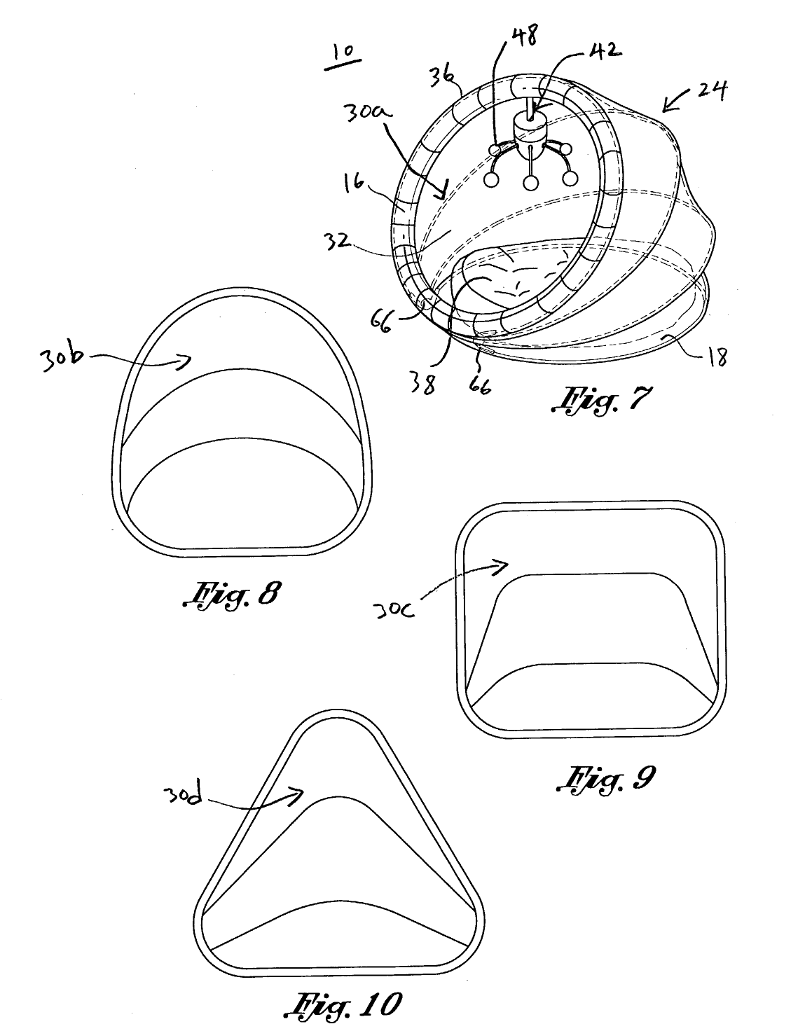

As shown in FIGS. 5 and 6, these biasing members 66 are preferably torsional spring assemblies which can be used for alternating the front flexible rod 16 between an extended position 12 and a stowed position 14 with respect to the base flexible rod 18. Although any type of biasing assembly which maintains the front flexible rod 16 in the extended position 12 can be used, each of the presently used biasing members 66 comprise a front receiver 76 and a base receiver 78 which dispose a torsional spring 80 therebetween. Such torsional spring 80 operates to assert a spring biased force which maintains the front receiver 76 generally perpendicular to the base receiver 78. Only by manually applying a force that opposes such spring biased force can the front receiver 76 move rotatably toward the base receiver 78.

The biasing members 66 are designed to engage the ends 68, 70, 72, 74 of the front and base flexible rods 16, 18. This allows the extended and stowed positions 12, 14 to be continually formed which in turn causes the structure housing 24 to be erected and collapsed. More specifically, the biasing member 66 disposed at the first housing location 54 engages the first front and base rod ends 68, 70 respectively through its front and base receivers 76, 78. Similarly, the biasing member 66 disposed at the second housing location 56 also engages the second front and base rod ends 72, 74 respectively through its own front and base receivers 76, 78.

By engaging the flexible rods 16, 18 in this manner, the base flexible rod 18 becomes disposed toward the ground while the front flexible rod 16 is naturally maintained generally perpendicular to the base flexible rod 18, thus defining the extended position 12. When a manual force is applied opposite to the spring biased force, the front flexible rod 16 is allowed to move toward the base flexible rod 18 through the rotation of each front receiver 76 to thereby form the stowed position 14. Upon reaching this position 14 wherein the front flexible rod 16 is now maintained generally parallel to the base flexible rod 18, fastening mechanisms such as loop and hook fastening strips 82, 84 which are respectively formed adjacent the front and base peripheral edges 34, 50 can be used to preserve the structure housing 24 in its collapsed state.

FIG. 11 illustrates a multi-purpose collapsible structure 100 which is constructed in accordance with an alternative embodiment of the present invention. This version of the collapsible structure 100 is committed to the similar functions of the above-embodied structure 10, but achieves them through a different structural makeup. In lieu of using the biasing members 66 and the flexible rods, 16, 18, 64, this alternatively embodied collapsible structure 100 rather utilizes an elongated coil spring 102 which is extended within a single aperture 104 formed along the structure housing 106 in a manner as to simulate the apertures 58, 60, 62 of the above-embodied collapsible structure 10.

More specifically, the multi-purpose collapsible structure 100 of the alternative embodiment includes a single aperture 104 which essentially spirals around the structure housing 106 from its front lower housing section 108 to its rear lower housing section 110. Such extension of the aperture 104 closely simulates the arrangement of those apertures 58, 60, 62 shown in FIG. 7 with the exception that it is an unitary aperture 104 that is fluidly laid between the front and rear lower housing sections 108, 110. Simply put, this aperture 104 commences from the front lower housing section 108 to spiral around the structure housing 106 toward the rear lower housing section 110 so as to terminate thereat.

As briefly mentioned above, a coil spring 102 which is preferably fabricated from metal or other types of materials is disposed and elongated within the extended aperture 104. More particularly, this coil spring 102 is preferably elongated within the aperture 104 from the front lower housing section 108 all the way to the rear lower housing section 110. When the coil spring 102 is confined within the aperture 104 in this manner, it has a tendency to expand away from its portions which are located in differing parts of the aperture 104. This is an occurrence which naturally and inevitably takes place due to the expanding natural characteristics of the coil spring 102.

Continuing the description of the alternatively embodied collapsible structure 100, the front and rear lower housing sections 108, 110 are brought together and maintained in that configuration. This causes the portions of the coil spring 102 disposed at those sections 108, 110 to be brought closer together, hence forming the particular shape of the structure housing 106 shown in FIG. 11. Although the front and lower housing sections 108, 110 may be maintained in close configuration through various methods (e.g., adhesives, staples, etc.), it is preferred that a piece of fabric 112 such as the one used to fabricate the structure housing 106 is sewn in to hold the two housing sections 108, 110 together.

In this respect, the structure housing 106 of the alternatively configured collapsible structure 100 naturally expands into the position as shown in FIG. 11. Only through axially compressing the coil spring 102 can the structure housing 106 be collapsed. Of course, similar to the collapsible structure 10 of the preferred embodiment, the alternatively embodied collapsible structure 100 may retain its collapsed shape through the use of fastening mechanisms such as loop and hook fastening strips or strips which may be interlocked or tied with each other.

All the provided figures are now referred to in order to describe the operation of the present multi-purpose collapsible structure 10. In operation, the present collapsible structure 10 is able to be used for a variety of applications but mainly used as a pet shelter, an infant play gym and/or a golf chipping target. To apply the collapsible structure 10 for these purposes, the already collapsed structure 10 is first taken out of storage for use in indoor or outdoor settings. Thereafter, the loop and hook fastening strips 82, 84 are unfastened wherein the structure housing 24 would then naturally spring up into the extended position 12. Thus, the structure housing 24 is now extended in its full configuration and is ready for utilization.

If the present collapsible structure 10 is to be used for sheltering pets, then its user may choose to place the cushion member 38 within the interior 32 of the structure housing 24. This would provide a layer of padding and thus comfort to the user's pets. This specified structure 10 would also apply toward being used as an infant play gym wherein the only difference might be the incorporation of toy anchor(s) 42 within the interior 32 of the structure housing 24. Of course, the present collapsible structure 10 may function toward these uses without the cushion member 38.

If the present collapsible structure 10 is intended to be used as a golf chipping target, then the user may simply face toward its opening 30 and strike the golf balls thereto. The golf balls would then travel along that direction into the opening 30 and be contained within the structure housing 24. By being contained therein, the golf balls can then be easily collected from the interior 32 of the structure housing 24.

After using the present collapsible structure 10, the cushion member 38 (if present) is taken out from the structure housing 24. Then, the collapsible structure 10 is collapsed into the stowed position 14 whereby the loop and hook fastening strips 82, 84 are fastened together in order to maintain the structure 10 in that position 14. The collapsible structure 10 is thereafter stored in a storage space for future use.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A multi-purpose collapsible structure, comprising:
a structure housing having front and base peripheral edges adjoined to each other;
front and base apertures elongated adjacent the front and base peripheral edges, respectively;
front and base flexible rods extended within the front and base apertures, respectively; and
a biasing member disposed at each location where the front and base rods converge toward each other to engage the rods therewith, each of the biasing members maintaining the front rod generally perpendicular to the base rod in an extended position whereby the front rod is movable thereto via application of force opposing the biasing members to thereby form a stowed position and collapse the structure housing.

2. The collapsible structure of claim 1 wherein the structure housing is fabricated from a fabric material.

3. The collapsible structure of claim 1 wherein the structure housing forms an opening between the front peripheral edge thereof.

4. The collapsible structure of claim 3 wherein the opening is a generally circular opening.

5. The collapsible structure of claim 3 wherein the opening is a generally triangular opening.

6. The collapsible structure of claim 3 further comprising a cushion member removably insertable within the structure housing via the opening.

7. The collapsible structure of claim 1 further comprising at least one toy anchor disposed within the structure housing for attaching at least one toy thereto.

8. The collapsible structure of claim 1 wherein the structure housing comprises an outer layer and an inner layer attached to each other.

9. The collapsible structure of claim 8 wherein the outer layer and the inner layer are stitched in a manner forming the front and base apertures therebetween adjacent the front and base peripheral edges, respectively.

10. The collapsible structure of claim 8 wherein the outer layer and the inner layer are each fabricated from a netted material.

11. The collapsible structure of claim 1 wherein the structure housing comprises at least one intermediate aperture elongated between the front and base apertures.

12. The collapsible structure of claim 11 wherein at least one intermediate flexible rod is extended within the at least one intermediate aperture.

13. The collapsible structure of claim 1 wherein the front and base flexible rods are each fabricated from a fiberglass material.

14. The collapsible structure of claim 1 wherein loop and hook fastening strips are respectively formed adjacent the front and base peripheral edges so as to engage each other when the front rod is moved to the base rod and forms the stowed position.

15. The collapsible structure of claim 1 wherein each of the biasing members comprise a base receiver and a front receiver which is maintained generally perpendicular thereto, the front receiver being rotatable toward the base receiver when the force opposing the biasing members is applied.

16. The collapsible structure of claim 15 wherein the front rod has first and second front rod ends and wherein the base rod has first and second base rod ends, the first front and base rod ends converging toward each other at a first housing location and respectively engaging the front and base receivers of the biasing member disposed thereat, the second front and base rod ends converging toward each other at a second housing location and respectively engaging the front and base receivers of the biasing member disposed thereat.

17. The collapsible structure of claim 1 wherein each of the biasing members are a torsional spring assembly.

18. The collapsible structure of claim 1 wherein the front and base apertures communicate with each other at each of the locations where the front and base rods converge.

19. The collapsible structure of claim 1 wherein the front rod is disposed generally parallel to the base rod when forming the stowed position.

20. The collapsible structure of claim 1 wherein an elongate cushion strip is extended along the front peripheral edge.

21. A multi-purpose collapsible structure, comprising:
a structure housing having a front lower housing section and a rear lower housing section;
an aperture extended around the structure housing from the front lower housing section to the rear lower housing section; and
an elongated coil spring disposed within the aperture and substantially extended between the front lower housing section and the rear lower housing section;
wherein the rear lower housing section is converged toward the front lower housing section to cause the coil spring to form an extended position whereby the coil spring is compressible into a stowed position thereafter via application of force to collapse the structure housing.

22. The collapsible structure of claim 21 wherein the structure housing is fabricated from a fabric material.

23. The collapsible structure of claim 21 wherein the elongated coil spring is fabricated from a metallic material.

24. The collapsible structure of claim 21 wherein the rear lower housing section is maintained adjacent the front lower housing section via a securing piece.

25. The collapsible structure of claim 24 wherein the securing piece is a piece of fabric sewn between the front lower housing section and a rear lower housing section.

26. The collapsible structure of claim 21 wherein the structure housing comprises fastening strips, the fastening strips being sized and configured to maintain the structure housing in the stowed position.

27. The collapsible structure of claim 26 wherein the fastening strips are loop and hook fastening strips.

28. The collapsible structure of claim 21 wherein the structure housing comprises a cushion member removably inserted therewithin.
